(19) United States
(12) Patent Application Publication
(10) Pub. No.: US 2019/0170147 A1
(43) Pub. Date: Jun. 6, 2019

(54) BLOWER UNIT

(71) Applicant: DENSO CORPORATION, Kariya-city (JP)

(72) Inventor: Tatsuya SAKAI, Kariya-city (JP)

(21) Appl. No.: 16/273,203

(22) Filed: Feb. 12, 2019

Related U.S. Application Data
(63) Continuation of application No. PCT/JP2017/020245, filed on May 31, 2017.

(30) Foreign Application Priority Data
Aug. 29, 2016 (JP) 2016-166952

(51) Int. Cl. F04D 25/08; F04D 29/42; F04D 17/16; F04D 25/06

(52) U.S. Cl. CPC F04D 25/082; F04D 29/4226; F05B 2240/14; F04D 25/0606; F04D 17/16

(57) ABSTRACT

A blower unit includes an electric motor, a fan, and a scroll casing. The scroll casing has a recess formed in an upper wall to define a nose portion where a scrolling of an air passage starts. The scroll casing has an air supply part communicating with a downstream side of the air passage in a flow of the air. The air supply part forms an air supply space to supply a part of the air flowing through the air passage to the electric motor. The scroll casing has a communication hole that causes an inside space of the recess and the air passage to communicate with each other without going through the air supply part. The air supply part has an intrusion suppressing portion configured to suppress entry of water into the air supply space.

### CROSS REFERENCE TO RELATED APPLICATIONS

The present application is a continuation application of International Patent Application No. PCT/JP2017/020245 filed on May 31, 2017, which designated the United States and claims the benefit of priority from Japanese Patent Application No. 2016-166952 filed on Aug. 29, 2016. The entire disclosures of all of the above applications are incorporated herein by reference.

### TECHNICAL FIELD

The present disclosure relates to a blower unit.

### BACKGROUND ART

A blower unit is mounted on a vehicle, and includes an electric motor, a fan for drawing air from one side in the axial direction and blowing out the air in the radial direction, and a scroll casing housing the fan and having a spiral air passage.

### SUMMARY

According to an aspect of the present disclosure, a blower unit includes: an electric motor having a rotation shaft; a fan that draws in air from one side in an axial direction of the rotation shaft and blows out the air in a radial direction of the rotation shaft; and a scroll casing housing the fan and having an air passage. The scroll casing has: a recess formed in an upper wall of the scroll casing to define a nose portion where a scrolling of the air passage starts; an air supply part communicating with a downstream side of the air passage in a flow of the air, the air supply part forming an air supply space to supply a part of the air flowing through the air passage to the electric motor; and a communication hole that causes an inside space of the recess and the air passage to communicate with each other without going through the air supply part. The air supply part has an intrusion suppressing portion configured to suppress entry of water into the air supply space.

### BRIEF DESCRIPTION OF DRAWINGS

FIG. 1 is a schematic perspective view illustrating a blower unit according to a first embodiment.

FIG. 2 is a schematic plan view illustrating the blower unit of the first embodiment.

FIG. 3 is a cross-sectional view taken along a line III-III in FIG. 2.

FIG. 4 is a cross-sectional view taken along a line IV-IV in FIG. 2.

FIG. 5 is a cross-sectional view taken along a line V-V in FIG. 4.

FIG. 6 is an explanatory diagram illustrating a flow of water accumulated in a recess of the blower unit of the first embodiment.

FIG. 7 is a cross-sectional view taken along a line VII-VII in FIG. 4.

FIG. 8 is an explanatory diagram illustrating a flow of cooling air from an air passage to an air supply part in the blower unit of the first embodiment.

FIG. 9 is a schematic cross-sectional view illustrating an air supply part according to a second embodiment.

FIG. 10 is a schematic view seen in an arrow direction X in FIG. 9.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

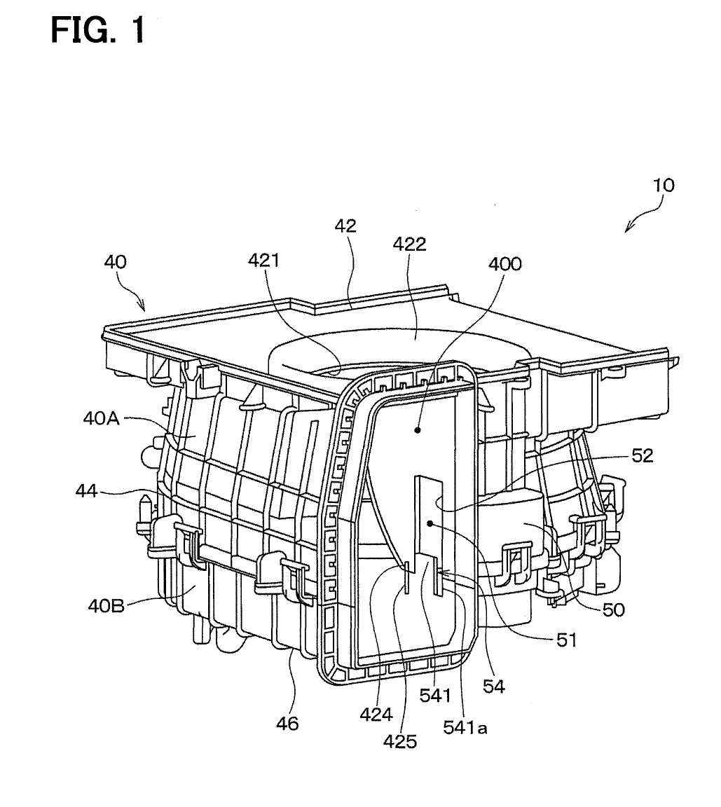

A first embodiment is described with reference to FIGS. 1 to 8. In the present embodiment, a blower unit 10 is applied to a vehicle air conditioner that air-conditions a passenger compartment. It should be noted that an arrow direction DRx in the drawings represents an up-down direction in a state where the blower unit 10 is mounted on the vehicle.

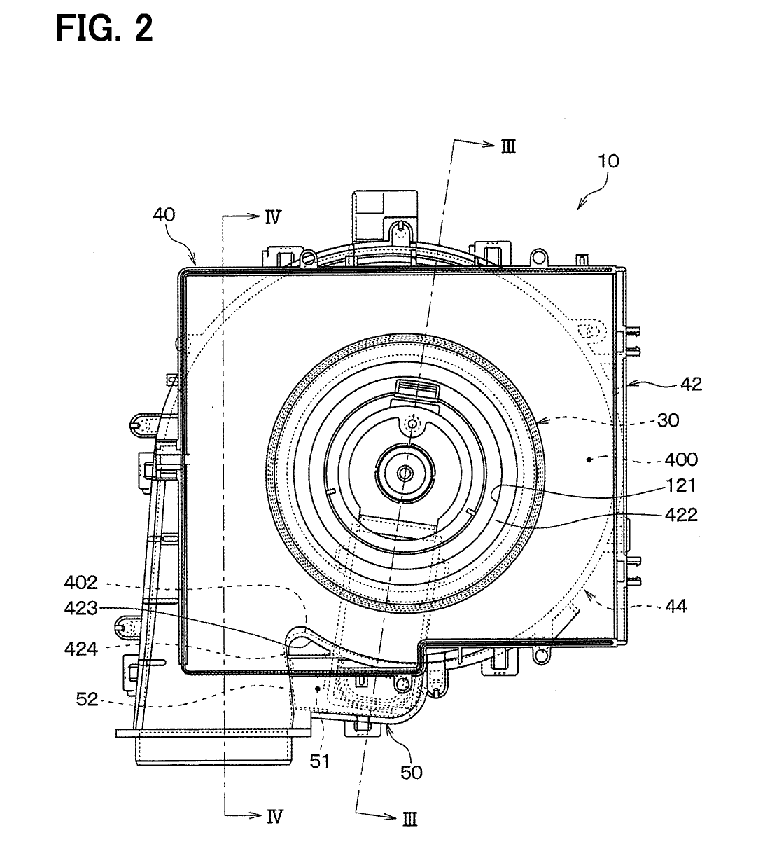

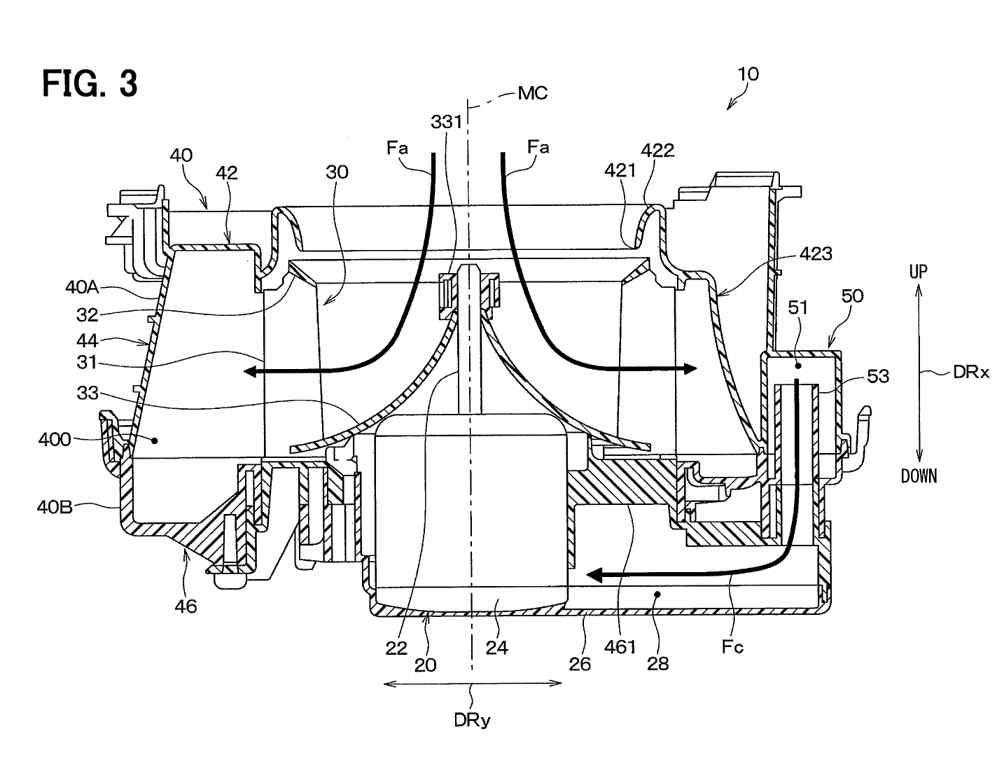

The blower unit 10 shown in FIGS. 1 and 2 generates a flow of air to be blown into the passenger compartment. As shown in FIG. 3, the blower unit 10 includes an electric motor 20, a fan 30, and a scroll casing 40.

The electric motor 20 rotates the fan 30. The electric motor 20 has a rotation shaft 22 connected to the fan 30, and a motor body 24 for rotationally driving the rotation shaft 22. The electric motor 20 is, for example, a DC motor with a brush. It should be noted that the electric motor 20 is not limited to a DC motor with a brush, and may be a brushless motor, an AC motor, or the like. In FIG. 3, the axis center MC, which is the rotation center of the electric motor 20, is indicated by an alternate long and short dash line. The extending direction of the axis center MC of the electric motor 20 corresponds to the axial direction of the rotation shaft 22.

The bottom surface of the electric motor 20 is covered with the motor cover 26. The motor cover 26 is connected to the scroll casing 40. A cooling air passage 28 is defined between the motor cover 26 and the scroll casing 40, and cooling air Fc for cooling the electric motor 20 flows through the cooling air passage 28. The cooling air passage 28 guides a part of the flow of air generated by the fan 30 to the electric motor 20 as the cooling air Fc.

The fan 30 is an air flow generator that generates a flow of air. As shown by a bold arrow Fa in FIG. 3, the fan 30 is a centrifugal fan, such as a sirocco fan, or a turbo fan, that draws in air from one side in the axial direction of the rotation shaft 22 and blows out the air in the radial direction DRy of the rotation shaft 22. The fan 30 is housed inside the scroll casing 40.

The fan 30 includes plural blades 31 arranged around the axis center MC of the electric motor 20, a side plate 32 connecting one ends of the blades 31, and a main plate 33 connecting the other ends of the blades 31.

The side plate 32 is made of an annular member whose center portion is opened. The side plate 32 functions as a suction part for introducing the air sucked from the bell mouth portion 422 of the scroll casing 40 into the fan 30.

The main plate 33 has a boss portion 331 connected to the rotation shaft 22 at the center portion thereof. The main plate 33 has a conical surface shape in which the center portion thereof protrudes toward the side plate 32. The shape of the main plate 33 may be a round plane.

The scroll casing 40 defines the outer shape of the blower unit 10. The scroll casing 40 is produced by assembling plural components made of resin. Specifically, the scroll casing 40 has an upper part 40A and a lower part 40B, and is formed by fastening the upper part 40A and the lower part 40B by a fastening member such as screw or snap fitting.

As shown in FIG. 2, an air passage 400 is formed in a spiral shape, inside of the scroll casing 40, on the outer side of the fan 30 in the radial direction DRy. The scroll casing 40 has a nose portion 402 that sets the start of the scrolling of the air passage 400. An upstream side and a downstream side of the air passage 400 communicate with each other through a slight clearance near the nose portion 402.

As shown in FIG. 1, the scroll casing 40 includes a bell mouth plate 42 that defines an upper wall, a side wall 44 connected to the bell mouth plate 42, and a bottom wall 46 connected to the side wall 44 to oppose the bell mouth plate 42.

As shown in FIG. 3, the bell mouth plate 42 has an air suction port 421 for sucking air at a position facing the side plate 32 of the fan 30. The bell mouth plate 42 has the bell mouth portion 422 around a periphery of the air suction port 421. The inner diameter of the bell mouth portion 422 is gradually increased toward the upstream side in the air flow so that air can flow easily to the air suction port 421. In the present embodiment, the air suction port 421 and the bell mouth portion 422 correspond to an air intake portion for drawing in air.

As shown in FIGS. 2 and 3, the bell mouth plate 42 has the recess 423 for forming the nose portion 402. The recess 423 is recessed from the bell mouth portion 422 of the bell mouth plate 42 toward the bottom wall 46.

The side wall 44 defines an outer shape of the blower unit 10 exposed to the outside in the radial direction DRy of the rotation shaft 22. The side wall 44 is formed in a spiral shape around the axis center MC of the rotation shaft 22.

The bottom wall 46 forms the air passage 400 together with the bell mouth plate 42 and the side wall 44. The bottom wall 46 forms the cooling air passage 28 together with the motor cover 26. A motor holder 461 is attached to the bottom wall 46, at a position facing the main plate 33 of the fan 30, and holds the motor body 24 of the electric motor 20.

Water may enter the blower unit 10 from the outside when it is raining, or when the vehicle is washed with water. The water may accumulate in the bell mouth plate 42. Since the bell mouth plate 42 has the recess 423, the water tends to accumulate particularly in the recess 423.

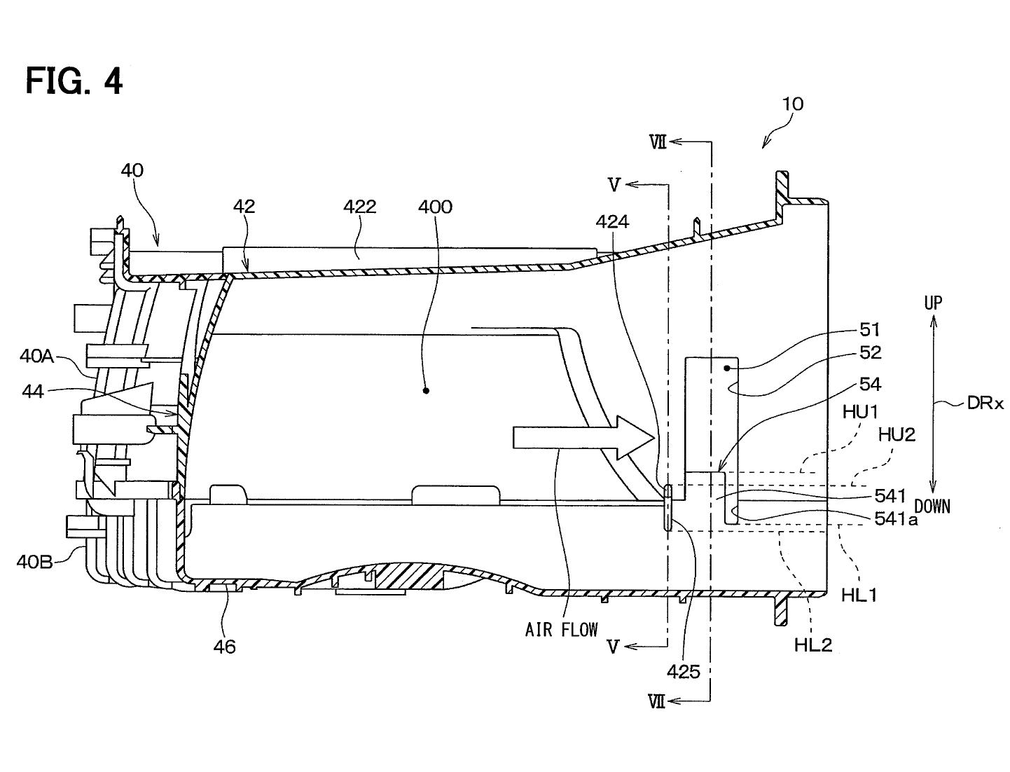

In the scroll casing 40 of the present embodiment, a communication hole 424 is provided in the recess 423 such that the air passage 400 and the inner space of the recess 423 communicate with each other. The water accumulated in the recess 423 is discharged to the air passage 400 via the communication hole 424. As shown in FIG. 4, the communication hole 424 is located at a position where the upper part 40A and the lower part 40B of the scroll casing 40 are in contact with each other.

As shown in FIG. 2, the communication hole 424 is positioned downstream of the air passage 400 in the flow of air, in the recess 423, such that the water discharged into the air passage 400 does not interfere with the fan 30. Specifically, the communication hole 424 of the present embodiment is formed in a part of the recess 423 not opposing to the fan 30.

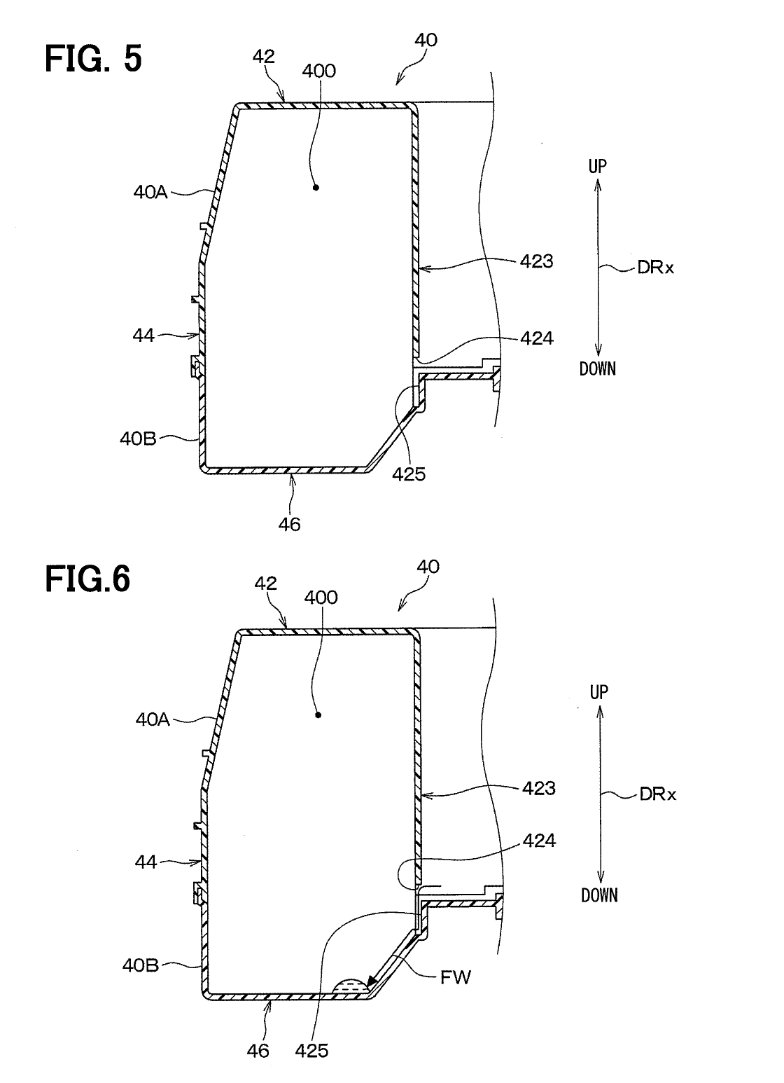

In addition, as shown in FIG. 5, the communication hole 424 is provided at a lower side of the recess 423 in order to improve the drainage performance from the recess 423. The size of the communication hole 424 is set to such a size that the air flowing through the air passage 400 is hard to flow back to the inner space of the recess 423 through the communication hole 424.

Further, the scroll casing 40 has a drainage guide groove 425 extending from the communication hole 424 toward the bottom wall 46. The drainage guide groove 425 is formed as a groove extending in the up-down direction DRx. The drainage guide groove 425 is formed in the lower part 40B of the scroll casing 40.

Consequently, in the scroll casing 40 of the present embodiment, the water accumulated in the recess 423 is discharged to the air passage 400 via the communication hole 424 as indicated by an arrow FW in FIG. 6. The water discharged to the air passage 400 through the communication hole 424 flows toward the bottom wall 46 of the scroll casing 40 along the drainage guide groove 425.

As shown in FIG. 2, the scroll casing 40 has an air supply part 50 that defines an air supply space 51 for supplying a part of the air flowing through the air passage 400 to the electric motor 20 via the cooling air passage 28. The air supply part 50 is provided adjacent to the recess 423 of the bell mouth plate 42 in the radial direction DRy.

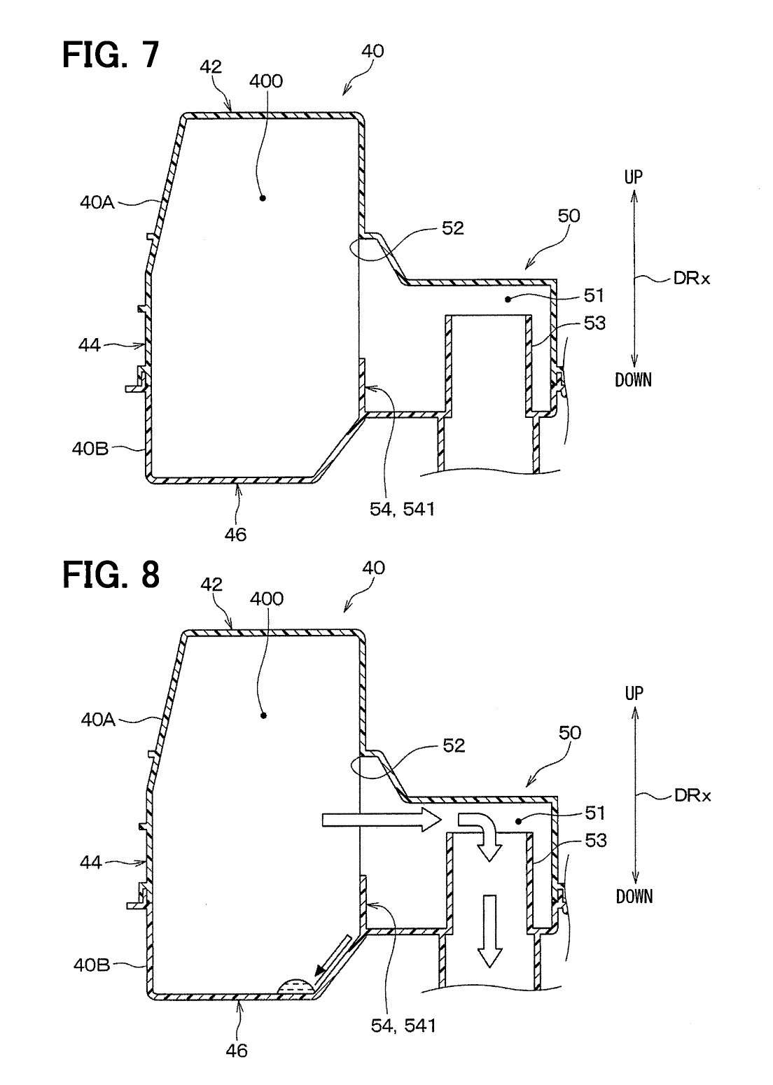

As shown in FIGS. 4 and 7, the air supply part 50 has a supply opening 52 for causing the air passage 400 and the air supply space 51 to communicate with each other. The supply opening 52 is formed in a portion of the air supply part 50 facing the air passage 400. The supply opening 52 is formed at a position downstream of the communication hole 424 in the flow of air, in the scroll casing 40.

The air supply part 50 has a pipe portion 53 for guiding the air from the air supply space 51 to the cooling air passage 28. The pipe portion 53 has the upper end opening positioned above the bottom portion of the air supply part 50, so that the water accumulated in the bottom portion of the air supply part 50 does not flow into the pipe portion 53.

Further, the air supply part 50 has an intrusion suppressing portion 54 for suppressing entry of water into the air supply space 51. The intrusion suppressing portion 54 has a rib 541 which closes a part of the supply opening 52 located near the communication hole 424.

As shown in FIG. 7, the rib 541 protrudes upward from the bottom of the air supply part 50. The upper end of the rib 541 is separated from the wall surface of the scroll casing 40 so that the supply opening 52 is formed on the upper side of the rib 541.

The rib 541 has a drain hole 541a for draining the water accumulated in the air supply space 51 to the air passage 400. The drain hole 541a is formed in a slit shape hole extending in the up-down direction. The drain hole 541a is formed in the rib 541 at a position away from the communication hole 424.

As shown in FIG. 4, the rib 541 is configured such that the upper end position HU1 of the rib 541 is located above the upper end position HU2 of the communication hole 424. In other words, the communication hole 424 is configured such that the upper end position HU2 of the communication hole 424 is positioned lower than the upper end position HU1 of the rib 541. Therefore, it is possible to suppress the water discharged from the communication hole 424 to the air passage 400 from entering the air supply space 51 together with the air flowing into the air supply space 51.

The drain hole 541a is configured such that the lower end position HL1 of the drain hole 541a is located above the lower end position HL2 of the drainage guide groove 425. It is possible to suppress the water flowing through the drainage guide groove 425 from entering the air supply space 51 via the drain hole 541a.

Next, the operation of the blower unit 10 of the present embodiment will be described. In the blower unit 10, the fan 30 is rotated by the rotation of the rotation shaft 22 of the electric motor 20. As a result, as shown in FIG. 3, due to the fan 30, the air sucked from one side in the axial direction of the rotation shaft 22 is blown out to the air passage 400 in the radial direction DRy.

As shown in FIG. 8, a part of the air blown into the air passage 400 flows into the air supply space 51 via the supply opening 52 of the air supply part 50. At this time, since the rib 541 is provided as the intrusion suppressing portion 54 in the supply opening 52, entry of water existing in the air passage 400 is suppressed.

As shown in FIG. 3, the air flowing into the air supply space 51 is supplied to the electric motor 20 via the pipe portion 53 and the cooling air passage 28. As a result, the electric motor 20 is cooled.

According to the blower unit 10 of the present embodiment, water accumulated in the recess 423 of the scroll casing 40 is directly discharged to the air passage 400. Therefore, the water accumulated in the recess 423 does not directly flow into the air supply space 51.

Further, the air supply part 50 has the intrusion suppressing portion 54 for suppressing entry of water from the air passage 400 to the air supply space 51. Therefore, in the blower unit 10 of the present embodiment, it is possible to suppress the water existing in the air passage 400 from entering the air supply space 51 via the supply opening 52.

Therefore, in the blower unit 10 of the present embodiment, it is possible to appropriately discharge the water accumulated in the recess 423 of the scroll casing 40 to the air passage 400 while suppressing the wetting of the electric motor 20.

Specifically, in the blower unit 10 of the present embodiment, the intrusion suppressing portion 54 is constructed by the rib 541 which closes a part of the supply opening 52 located near the communication hole 424. In this way, when a part of the supply opening 52 located close to the communication hole 424 is closed by the rib 541, the water discharged from the communication hole 424 to the air passage 400 can be suppressed from flowing into the air supply space 51 through the supply opening 52.

Further, the rib 541 has the drain hole 541a shaped in the slit extending in the up-down direction. As a result, in the blower unit 10 of the present embodiment, even if water enters the air supply space 51 via the supply opening 52, the water can be drained into the air passage 400 through the drain hole 541a, so that it is possible to sufficiently suppress the wetting of the electric motor 20.

Furthermore, since the drainage guide groove 425 extending from the communication hole 424 toward the bottom wall 46 is formed in the scroll casing 40, the water discharged from the communication hole 424 to the air passage 400 easily flows along the drainage guide groove 425 toward the bottom wall 46. Therefore, in the blower unit 10 of the present embodiment, it is possible to sufficiently suppress the water discharged from the communication hole 424 to the air passage 400 from flowing into the electric motor 20 via the supply opening 52.

### Second Embodiment

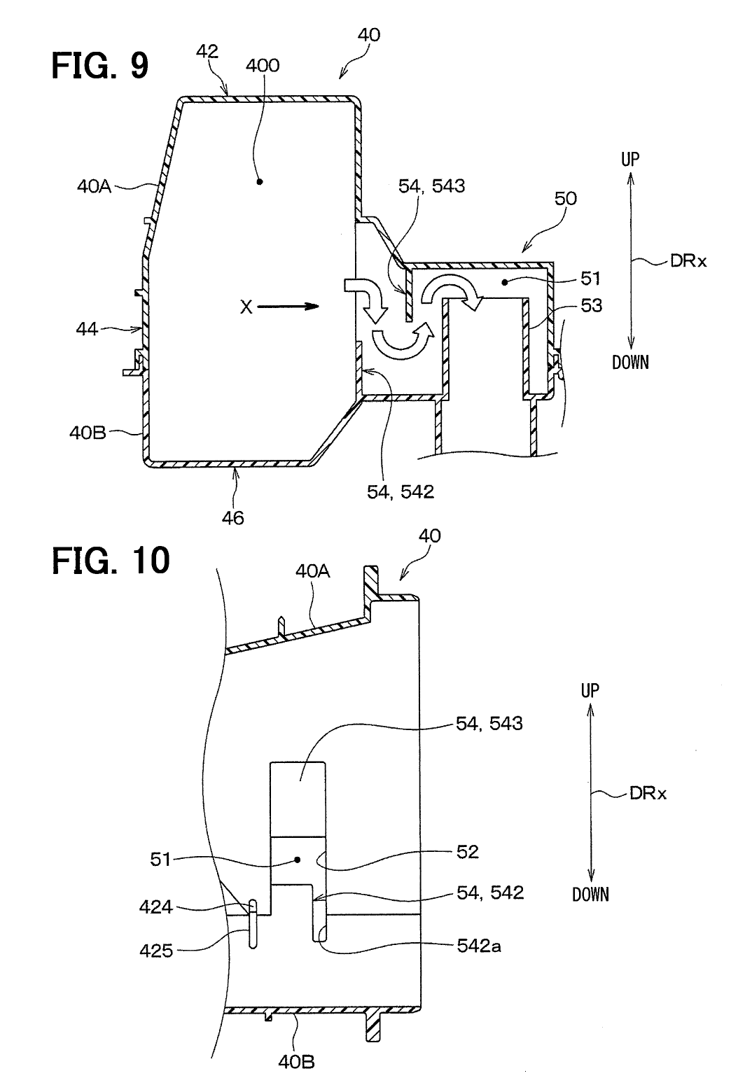

A second embodiment is described with reference to FIG. 9 and FIG. 10. The air supply part 50 of the blower unit 10 of the present embodiment is different from that of the first embodiment. FIG. 9 is a schematic cross-sectional view in the vicinity of the air supply part 50 of the present embodiment, and corresponds to FIG. 7 of the first embodiment.

As shown in FIG. 9, in the present embodiment, the intrusion suppressing portion 54 of the air supply part 50 for suppressing the intrusion of water into the air supply space 51 is constructed of plural ribs 542, 543. Specifically, the intrusion suppressing portion 54 of the present embodiment has a lower rib 542 extending upward from a lower side of the supply opening 52 and an upper rib 543 extending downward from an upper side of the supply opening 52 so that the air supply space 51 has a labyrinth structure.

The lower rib 542 closes a part of the supply opening 52 located near the communication hole 424. Specifically, the lower rib 542 is formed of the same rib as the rib 541 of the first embodiment.

The lower rib 542 of the present embodiment, as shown in FIG. 10, has a drain hole 542a shaped in a slit extending in the up-down direction. Since the drain hole 542a is configured similarly to the drain hole 541a described in the first embodiment, its description will be omitted.

As shown in FIG. 9, the upper rib 543 is formed at a position more distanced from the air passage 400 than the lower rib 542 is in the air flowing direction. Specifically, the upper rib 543 is located between the supply opening 52 and the pipe portion 53 in the air flowing direction, in the air supply space 51.

In addition, the lower end of the upper rib 543 is separated from the bottom of the air supply part 50 so that a clearance is formed for the flow of the cooling air. Specifically, the upper rib 543 of the present embodiment is configured such that the lower end position of the upper rib 543 is located lower than the upper end position of the pipe portion 53. Therefore, water existing in the air supply space 51 can be restricted from entering the pipe portion 53.

The other structures are similar to the corresponding structures of the first embodiment. The blower unit 10 of the present embodiment can obtain the same effect as the blower unit 10 of the first embodiment, which is obtained from the configuration common to the first embodiment.

The blower unit 10 of the present embodiment includes the intrusion suppressing portion 54 constructed by the lower rib 542 which extends from the lower side to the upper side and the upper rib 543 which extends from the upper side to the lower side.

Therefore, in the blower unit 10 of the present embodiment, the air flowing into the air supply space 51 via the supply opening 52 flows up and down in the air supply space 51 and then passes through the pipe portion 53. In this way, since the air supply space 51 has a labyrinth structure, the water discharged from the communication hole 424 to the air passage 400 can be sufficiently suppressed from flowing into the electric motor 20 via the air supply space 51.

The lower rib 542 of the present embodiment has the drain hole 542a shaped in a slit extending in the up-down direction. As a result, in the blower unit 10 of the present embodiment, even if water enters the air supply space 51 via the supply opening 52, the water can be drained into the air passage 400 through the drain hole 541a, so that it is possible to sufficiently suppress the wetting of the electric motor 20.

### Other Embodiments

Although the representative embodiments have been described above, the present disclosure should not be limited to the above-described embodiments. For example, various modifications can be made as follows.

In the first embodiment described above, the intrusion suppressing portion 54 is configured by the rib 541 that closes a part of the supply opening 52 located near the communication hole 424, but is not limited thereto. For example, the rib 541 of the intrusion suppressing portion 54 may be located away from the communication hole 424 to close a part of the supply opening 52.

As in the first embodiment, it is preferable to form the drain hole 541a in the rib 541, but is not limited thereto. The intrusion suppressing portion 54 may not have the drain hole 541a formed in the rib 541.

It is preferable to form the drainage guide groove 425 in the scroll casing 40 as in the first embodiment, but is not limited thereto. The scroll casing 40 may not have the drainage guide groove 425.

In the second embodiment, the intrusion suppressing portion 54 is configured by two ribs, that is, the lower rib 542 and the upper rib 543, but is not limited thereto. The intrusion suppressing portion 54 may be composed of three or more ribs. Further, the intrusion suppressing portion 54 is not limited to the rib extending in the up-down direction DRx, but may also be a rib extending in a direction intersecting the up-down direction DRx.

It is preferable to form the drain hole 542a in the lower rib 542 as in the second embodiment, but is not limited thereto. The intrusion suppressing portion 54 may not have the drain hole 542a formed in the lower rib 542.

In the respective embodiments, it goes without saying that elements forming the embodiments are not necessarily essential unless specified as being essential or deemed as being apparently essential in principle.

In a case where a reference is made to the components of the respective embodiments as to numerical values, such as the number, values, amounts, and ranges, the components are not limited to the numerical values unless specified as being essential or deemed as being apparently essential in principle.

Also, in a case where a reference is made to the components of the respective embodiments above as to shapes and positional relations, the components are not limited to the shapes and the positional relations unless explicitly specified or limited to particular shapes and positional relations in principle.

Examples of relevant techniques will be described as a comparison example. In a comparison example, an air blowing unit is configured to discharge water accumulated in a recess to an air passage via a space that supplies air to the electric motor.

In the comparison example, since water flows in the space for supplying air to the electric motor, the electric motor may be easily wetted. Wetting of the electric motor is not preferable because the wetting causes a damage to the electric motor.

In contrast, according to the present disclosure, the blower unit is capable of discharging water accumulated in the recess to the air passage while suppressing the electric motor from being wetted. The blower unit may be mounted on a vehicle.

According to one aspect of the present disclosure, the blower unit includes: an electric motor having a rotation shaft; a fan that draws in air from one side in an axial direction of the rotation shaft and blows out the air in a radial direction of the rotation shaft; and a scroll casing housing the fan and having a scroll air passage.

The scroll casing has an upper wall having a suction port for drawing in air, a side wall connected to the upper wall, and a bottom wall connected to the side wall to oppose the upper wall.

The scroll casing has: a recess formed in the upper wall to define a nose portion that regulates a start of scrolling of the air passage; an air supply part communicating with a downstream side of the air passage in a flow of the air, the air supply part forming an air supply space to supply a part of the air flowing through the air passage to the electric motor; and a communication hole that causes an inside space of the recess and the air passage to communicate with each other without going through the air supply part. The air supply part has an intrusion suppressing portion configured to suppress entry of water into the air supply space.

Accordingly, the water accumulated in the recess of the scroll casing is directly discharged into the air passage, so that water entering the recess does not directly flow into the air supply space. Further, the air supply part is provided with the intrusion suppressing portion for suppressing entry of water from the air passage to the air supply space.

Therefore, according to the blower unit of the present disclosure, it is possible to discharge the water accumulated in the recess formed in the scroll casing to the air passage while suppressing the wetting of the electric motor.

According to the first aspect represented by a part or all of the above embodiments, the blower unit is provided with a communication hole in the scroll casing for communicating the inside space of the recess and the air passage with each other without going through the air supply part. The air supply part is provided with an intrusion suppression unit for suppressing entry of water into the air supply space.

According to the second aspect, the air supply space of the blower unit communicates with the air passage via the supply opening formed in the air supply part. The intrusion suppressing portion includes at least one rib that closes a part of the supply opening located near the communication hole.

In this way, since the intrusion suppressing portion includes the rib to close a part of the supply opening located near the communication hole, the water discharged from the communication hole to the air passage can be restricted from flowing into the air supply space.

According to the third aspect, in the blower unit, the rib has a slit-shaped drain hole extending in the vertical direction. Accordingly, even if water intrudes into the air supply space through the supply opening, the water is drained to the air passage via the drain hole, so that the wetting of the electric motor can be suppressed sufficiently.

According to the fourth aspect, the air supply space of the blower unit communicates with the air passage via the supply opening formed in the air supply part. The intrusion suppressing portion includes a lower rib extending from the lower side to the upper side and an upper rib extending from the upper side to the lower side so that the air supply space has a labyrinthine structure.

In this way, since the air supply space has a labyrinth structure, it is possible to sufficiently suppress the water discharged from the communication hole to the air passage from flowing into the electric motor via the air supply space.

According to the fifth aspect, in the blower unit, the lower rib has a slit-shaped drain hole extending in the vertical direction. Accordingly, even if water intrudes into the air supply space through the supply opening, the water is drained to the air passage via the drain hole, so that the wetting of the electric motor can be suppressed sufficiently.

According to the sixth aspect, the blower unit has a drainage guide groove formed in the scroll casing and extending from the communication hole toward the bottom wall. Accordingly, the water discharged from the communication hole to the air passage easily flows toward the bottom wall along the drainage guide groove. Therefore, it is possible to sufficiently suppress the water discharged from the communication hole to the air passage from flowing into the electric motor via the supply opening.

What is claimed is:

1. A blower unit comprising:
an electric motor having a rotation shaft;
a fan that draws in air from one side in an axial direction of the rotation shaft and blows out the air in a radial direction of the rotation shaft; and
a scroll casing housing the fan and having an air passage, wherein
the scroll casing has
an upper wall having a suction port for drawing in air,
a recess formed in the upper wall to define a nose portion where a scrolling of the air passage starts,
an air supply part communicating with a downstream side of the air passage in a flow of the air, the air supply part forming an air supply space to supply a part of the air flowing through the air passage to the electric motor, and
a communication hole that causes an inside space of the recess and the air passage to communicate with each other without going through the air supply part, and
the air supply part has an intrusion suppressing portion configured to suppress entry of water into the air supply space.

2. The blower unit according to claim 1, wherein
the air supply space communicates with the air passage via a supply opening formed in the air supply part, and
the intrusion suppressing portion includes at least one rib that closes a part of the supply opening located near the communication hole.

3. The blower unit according to claim 2, wherein
the rib has a drain hole shaped in a slit extending in an up-down direction.

4. The blower unit according to claim 1, wherein
the air supply space communicates with the air passage via a supply opening formed in the air supply part,
the intrusion suppressing portion has
a lower rib extending upward from a lower side of the supply opening, and
an upper rib extending downward from an upper side of the supply opening, and
the air supply space has a labyrinth structure defined by the lower rib and the upper rib.

5. The blower unit according to claim 4, wherein
the lower rib has a drain hole shaped in a slit extending in an up-down direction.

6. The blower unit according to claim 1, wherein
the scroll casing has
a side wall connected to the upper wall,
a bottom wall connected to the side wall to oppose the upper wall, and
a drainage guide groove extended from the communication hole toward the bottom wall.
